(19) United States
(12) Patent Application Publication
(10) Pub. No.: US 2026/0147396 A1
(43) Pub. Date: May 28, 2026

(54) HIGH CURRENT RATE-OF-CHANGE MITIGATION

(71) Applicant: Meta Platforms, Inc., Menlo Park, CA (US)

(72) Inventors: Rohan Prakash Mallya, Fremont, CA (US); Linda Cheng, San Jose, CA (US); Kaushal Gandhi, South San Francisco, CA (US); Soheil Gharahi, Austin, TX (US)

(73) Assignee: Meta Platforms, Inc., Menlo Park, CA (US)

(21) Appl. No.: 19/398,468

(22) Filed: Nov. 24, 2025

Related U.S. Application Data
(60) Provisional application No. 63/725,388, filed on Nov. 26, 2024.

(51) Int. Cl. G06F 1/28; H02H 9/00

(52) U.S. Cl. CPC G06F 1/28; H02H 9/001

(57) ABSTRACT

A system and method for mitigating sharp increases in power consumption associated with integrated circuits that may compute large workloads (e.g., computations). A processor may receive a signal associated with a workload. When the workload is determined to be above a workload threshold, a first signal may be sent to a compute engine to initiate a background computation for a ramp up period to increase the power consumption to a threshold. The workload may be performed following the ramp up period. The processor may send a second signal in response to the end of performing the workload. The second signal may initiate a background computation for a ramp down period, such that the power consumption in a ramp down period does not rapidly decrease to zero following a workloads computation.

### CROSS-REFERENCE TO RELATED APPLICATION

This application claims the benefit of US Application No. 63/725,388, filed November 26, 2024, the entirety of which is hereby incorporated by reference.

### TECHNOLOGICAL FIELD

The present invention relates generally to managing the power stability in an integrated circuit.

### BACKGROUND

With the rapid advancement of artificial intelligence (AI) and machine learning (ML) there has been an increased demand for specialized hardware capable of efficiently processing complex algorithms and large datasets. Application-Specific Integrated Circuits (ASICs) have emerged as a critical technology in AI and ML technologies, offering tailored solutions that outperform general-purpose processors in specific tasks.

### SUMMARY

Operating a large number of ASICs or engines (e.g., processors or the like) associated with an ASIC may greatly increase computing power, it also may raise power stability concerns, particularly when a large load or computational output is needed. The disclosed subject matter provides methods and systems for managing power consumption in integrated circuits, while not sacrificing performance.

In an example, systems, methods, or devices may include receiving a signal associated with a workload, where the signal may be sent to a processor to initiate the workload. When the workload is determined to be above a workload threshold, a first warning signal may be sent to a compute engine to initiate a background computation within a ramp up period. The workload may be performed after the ramp up period. The processor may send a second warning signal in response to the end of performing the workload. The second warning signal may initiate the background computation in a ramp down period such that the power consumption does not immediately fall to zero following a workload computation.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example integrated circuit (IC) in accordance with an example of the present disclosure.

FIG. 2 illustrates an example method in accordance with an example of the present disclosure.

FIG. 3A illustrates an example process in accordance with an example of the present disclosure.

FIG. 3B illustrates an example process in accordance with an example of the present disclosure.

FIG. 3C illustrates an example process in accordance with an example of the present disclosure.

FIG. 4 illustrates an example block diagram of an example computing device suitable for implementing aspects of the disclosed subject matter.

FIG. 5 is a diagram of an exemplary computing system in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received, or stored in accordance with examples of the invention. Moreover, the term “exemplary,” as used herein, is not provided to convey any qualitative assessment, but instead merely to convey an illustration of an example. Thus, use of any such terms should not be taken to limit the spirit and scope of examples of the invention.

With the rapid advancement of artificial intelligence (AI) and machine learning (ML) there has been an increased demand for specialized hardware capable of efficiently processing complex algorithms or large datasets. Many AI or ML systems may utilize Application-Specific Integrated Circuits (ASICs) designed to accelerate computations, but they may face significant power consumption challenges. As ML models increase in complexity and size, ASICs' power demands may skyrocket, leading to thermal, energy efficiency, and cost concerns. The primary power issue may stem from the massive number of computations, memory accesses, or data movements required for ML workloads. The high-density, low-latency, or high-bandwidth memory interfaces, as well as the complex arithmetic logic units, may contribute to substantial power consumption.

The power issue may be more apparent in systems in which a number of ASICs may be used in tandem on a chip to compute information. In such systems, there may be moments when a computation may require a majority if not all of the ASICs or compute engines within an ASIC to synchronize and function at once thus causing a sharp spike in power consumption (discussed herein as di/dt). A high current rate of change (di/dt) event may be a sudden increase in current draw on the chip in a short period of time. One or more of on-chip capacitors or on-board capacitors may both present as backup reserves when such events happen. However, there is a concern that during the start of intense workloads (e.g., computations) capacitors may not be enough to prevent a voltage drop below operational limits. Additionally, in such scenarios, the resistance times capacitance (RC) time to charge the capacitors back to working order, may be longer than it takes for a subsequent spike to happen. Thus, when the voltage drops low, there could be transmission errors, lockups, unexpected failures, or the chip may become nonoperational.

For example, compute engines on ML ASIC’s may often collaboratively process large tensors, dividing the workload amongst themselves. As such, there may be a sudden draw of current (e.g., a high current rate of change(di/dt)) as the compute engines may simultaneously engage in computations. Additionally, the same scenario may occur as the current may surge towards zero as the compute engines disengage (e.g., end computations). The sudden change in current (e.g., a spike up to maximum current or spike to zero current) may cause voltage droop or a surge beyond an ASIC’s operational limits. There are methods to mitigate the di/dt issue, however, conventional methods may negatively impact performance or increase the cost of manufacturing.

As such, there may be a need for a more efficient and cost effective technique using traditional software or hardware components that may mitigate the sharp spike in current in a short period of time (e.g., di/dt problem). The system and methods, as disclosed herein, may manage voltage sag and overshoot due to rapid changes in power consumption in integrated circuits, without sacrificing performance.

The disclosed subject matter may address power consumption concerns associated with chips comprising a number of integrated circuits (ICs). By ramping up the compute engine to a threshold, the system may mitigate sharp spikes in power consumption that may disrupt chip performance.

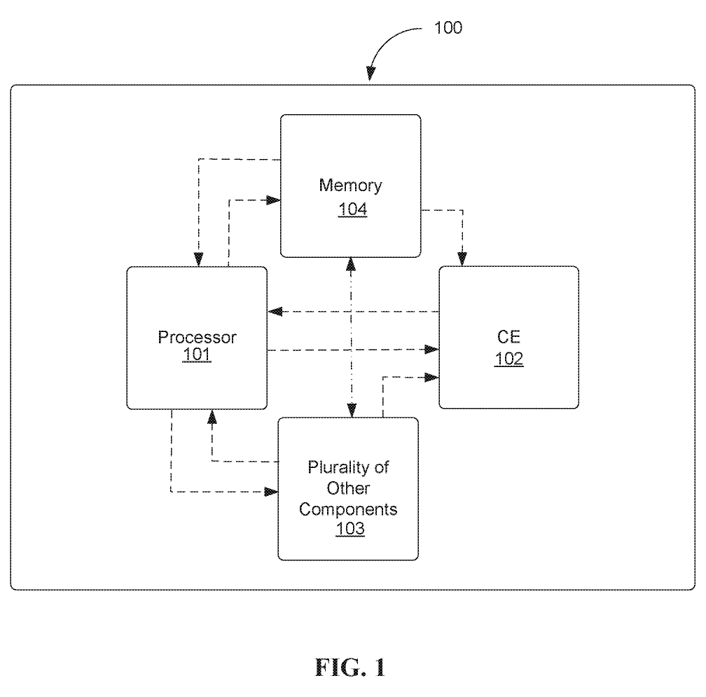

FIG. 1 illustrates an example integrated circuit (IC) 100 according to example aspects of the present disclosure. The IC 100 may be capable of performing computations, processes, training, and interference, or the like. The IC 100 may include a processor 101, a compute engine (CE) 102, or a memory 104. In some examples, IC 100 may be connected with one or more other ICs or associated with a chip (e.g., a semiconductor or the like). For simplicity, the FIG. 1 may illustrate a simple illustration of IC 100 including a processor 101, a CE 102, or a memory 104, however, it is contemplated that the IC 100 may include a plurality of other components 103.

The plurality of other components 103 may be any suitable component associated with an IC 100, such as but not limited to, one or more of: a reduction engine, special functions unit, memory layout unit, or any combination thereof.

The processor 101 may include one or more physical devices, such as microprocessors, application processors, microcontrollers, programmable logic devices, microcontrollers, RISC-V or ARM-based processors, Finite State Machines (FSMs), or any other suitable programmable means.. In some examples, the processor 101 may be considered a Central Processing Unit (CPU) or an information manager (e.g., command processor). Processor 101 may be configured to perform operations such as the execution of programmable instructions associated with a system. Processor 101 may comprise programmable instructions to manage data associated with the IC 100, control flow of information within the IC 100, or any other suitable operation. The processing operations may be related to power management. The processor 101 may be configured to fetch instructions from a memory (e.g., memory 104 or any other suitable memory), decode the instructions, and based on the decoded instructions execute operations. In some examples, the processor may perform arithmetic and logical operations as well as bitwise operations. In some examples, the processor may be configured to manage data transfer between various components within the IC 100, including but not limited to memory, peripherals, CE 102, a plurality of other components 103, or other processing units. In some examples, the processor 101 may include instructions associated with power management features, such as clock gating, voltage scaling, power gating, or the like to minimize power consumption.

In some examples, the power management associated with the processor 101 may include dynamic control of power consumption to optimize energy efficiency while maintaining performance. The processor 101 may be configured to anticipate and adjust power delivery based on a potential requirement associated with a workload. The processor 101 may use various techniques or methods to estimate or predict the power associated with a workload. In an example, the processor 101 may analyze instructions to predict power consumption based on operand values, instruction types, or execution paths. In an example, the processor may utilize historical data on power consumption patterns to anticipate future power requirements associated with the workload. In an example, the processor 101 may utilize one or more machine learning algorithms to learn power consumption patterns and adapt to changing workloads. In an example, the processor 101 may adjust the voltage or frequency to match predicted power requirements, via voltage scaling. In such examples, the processor 101 may reduce the voltage to decrease power consumption during low-load conditions. The processor 101 may be configured to perform frequency scaling to adjust clock frequency to balance performance and power consumption. The processor 101 may include executable instructions to ramp up the CE 102 to a threshold. The threshold may be any suitable fraction of maximum power consumption available to the system, for example, the threshold may be 50% of the maximum power consumption.

The processor 101 may be configured to interpret and execute instructions, commands, control signals, or the like. In an example, the processor 101 may be configured to receive commands from external sources, such as software, firmware, a plurality of other components 103, or other any other suitable components. In this example, processor 101 may receive commands and decode them to be executed corresponding to actions, which may control IC 100 functionality. In an example, the processor 101 may configure the IC’s 100 registers, settings, and operating modes. The processor 101 may initialize one or more components (e.g., CE 102 or plurality of other components 103) of IC 100. In an example, processor 101 may be configured to monitor data transfer between one or more components of IC 100 and external devices, such as memory, peripherals, or other ICs. In an example, the processor 101 may be configured to manage the flow of operations associated with the IC, ensuring tasks are executed and executed in the correct sequence. In an example, the processor 101 may be configured to detect and handle errors. In such examples, the processor 101 may be configured to take corrective actions associated with errors or notify external components or devices.

The processor 101 may be utilized to optimize IC 100 performance by scheduling tasks to minimize latency, allocating resources to maximize throughput, managing power consumption, or the like. In an example, processor 101 may be configured to provide (e.g., transmit or send) an activity signal to a CE 102. The processor 101 may be configured to send a trigger (e.g., a warning signal) to CE 102, such that CE 102 may begin to perform computations which may increase the power consumption of the system (e.g., a chip). In some examples, the processor 101 may be configured to analyze the type of matrix multiplication to be completed via CE 102. The processor 101 may comprise a register associated with enabling one or more workloads to trigger a background compute feature in the CE 102. When the register is set, the associated type of workload may trigger, via a warning signal, the CE 102 to background compute. In some examples, background compute may refer to the CE 102 performing computations to begin drawing power consumption associated with a threshold. The warning signal may initiate computations that may relate to fake computations that may not be necessary to a request of the IC.

The processor 101 may access instructions, information from, and store data in, any type of memory 104 associated with the IC 100. Memory 104 may include random access memory (RAM), read-only memory (ROM), a hard disk, a subscriber identity module (SIM) card, a memory stick, a secure digital (SD) memory card, or any other type of memory storage device. In other examples, the processor 101 may access information from, and store data in, memory 104 that is not physically located on the IC 100, such as on a server, a computer, a chip, or another IC.

The CE 102 may be a specialized hardware accelerator designed to efficiently compute mathematical operations associated with machine learning operations. The CE 102 may compute mathematical operations such as but not limited to dot products, an operation in many machine learning operations. In an example, the CE 102 may be configured to compute dot products of two vectors producing a scalar result. This may be utilized in neural networks, linear regression, or signal processing. In an example, CE 102 may be configured to accelerate matrix multiplication to aid in deep learning, training of machine learning systems, scientific simulations, and data analysis. The CE 102 may be configured to compute background matrix multiplication in moments when the compute engine may be idle or at a rest state. In an example, CE 102 may be configured to compute background matrix multiplication based on a smart activity trigger mechanism. The smart activity trigger mechanism may cause the CE 102 to begin to warm up (e.g., begin to pull some power) before real computations may be needed. The smart activity trigger mechanism may use configurable rate, configurable data, a ramp up period associated with a threshold, or a ramp down period associated with the threshold. Alternatively, CE 102 may continuously perform a warning compute of matrix multiplication such that the CE 102 may be at a threshold associated with the power consumption. The threshold may be any suitable percentage of a maximum power consumption, for example, the threshold may be 50% of a maximum power consumption. The ramp up period may be a configurable period of time prior to a workload that may require significant power to produce. In an example, the CE 102 may be configured to receive a signal, information, data, or the like, to initiate a warning compute in the ramp up period. Conversely, the ramp down period may be a configurable period of time after a workload that may require a significant power to produce. In an example, CE 102 may be configured to receive a signal, information, data, or the like, to initiate a warning compute in the ramp down period following a workload that may utilize a large amount of power.

Although FIG. 1 illustrates a particular arrangement of a processor 101, CE 102, memory 104, or plurality of other components 103, among other things, this disclosure contemplates any suitable arrangement. The components of IC 100 may be physically or logically co-located with each other in whole or in part. It should be pointed out that although FIG. 1 shows one processor 101, CE 102,memory 104, or plurality of other components 103, any suitable number of processors 101, CE 102, memory 104, or plurality of other components 103 may be part of the IC 100 of FIG. 1 without departing from the spirit and scope of the present disclosure.

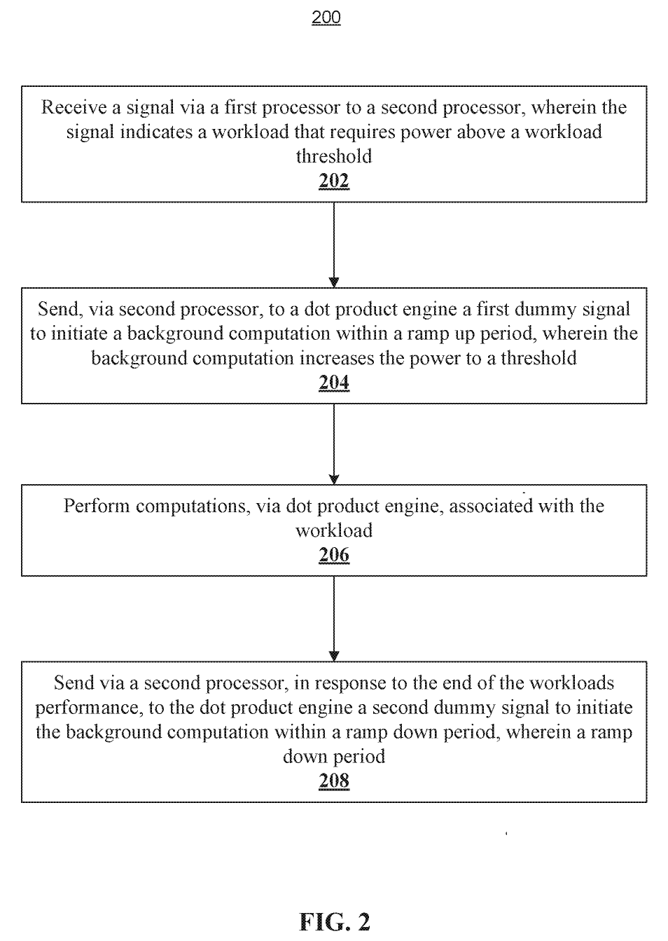

FIG. 2 illustrates a method 200 for managing power consumption. At step 202, a processor (e.g., processor 101) may receive a signal (e.g., workload signal) associated with a workload. The workload signal may provide information associated with the workload. The processor 101 may utilize the workload signal to determine a potential power associated with the workload. The potential power may be defined as a determined, via processes of the processor, power necessary to perform a computational output associated with the workload received. In an example, the potential power may be determined to be compared to a workload threshold. The workload threshold may be any suitable power consumption estimate (e.g., potential power) that may initiate the IC 100 to utilize a certain portion of power that may affect performance of the IC 100. For example, the workload threshold may be 90% of the maximum power consumption associated with IC 100. When the workload signal does not indicate a workload above the workload threshold the method 200 may stop at step 202 until another workload signal is received. Workload signals below the workload threshold may be considered non-qualifying computes (e.g., nq compute), meaning that a considerable amount of power may not be necessary to compute that workload. Conversely, when the signal does indicate a workload above the workload threshold, the method 200 may continue to step 204.

At step 204, the processor (e.g., processor 101) may send a first signal (e.g., a first warning signal) to a compute engine (e.g., CE 102). The first signal may be configured to initiate the CE 102 to perform a background computation (e.g., a warning computation). The background computation may be utilized to increase the power consumption associated with IC 100 to a threshold within a ramp up period. The threshold may be any suitable percentage below the maximum (e.g., 100%) power consumption of the IC 100, for example, the threshold may be 50% of the maximum power consumption. The ramp up period may be configured to define a time period at which the power consumption of the IC 100 may gradually increase from a lower or zero level to a maximum level (e.g., 100% power consumption). The duration of the ramp up period may be determined by the IC 100 or any other suitable component of IC 100. In some examples, the duration of the ramp up period or the threshold may be dependent of the potential power associated with the workload. Alternatively, in some examples, one or more workload signals may be received. In this example, where one of the one or more workload signals is identified as being non-qualifying compute and the one of the one or more workload signals is above the workload threshold. In such an example, the CE 102 may be configured to compute the non-qualifying compute while the CE 102 is waiting for the qualified compute (e.g., above the workload threshold) to arrive. Performing the nonqualified compute (e.g., nq compute) may not disrupt or count towards the ramp up period.

At step 206, the CE 102 may perform computations associated with the workload (e.g., workload signal). The computations associated with the workload may be performed following the ramp up period. The computations associated with the workload may increase the power of IC 100 from the threshold to a maximum power associated with the workload signal.

At step 208, the processor (e.g., processor 101) may send a second signal (e.g., a second warning signal) to the CE 102. The second signal may be configured to initiate the CE 102 to perform a background computation (e.g., a warning computation). The background computation may be utilized to increase the power consumption associated with IC 100 to a threshold within a ramp down period. The threshold may be any suitable percentage below the maximum (e.g., 100%) power consumption of the IC 100, for example, the threshold may be 50% of the maximum power consumption. The ramp down period may be configured to define a time period at which the power consumption of the IC 100 may gradually decrease from the threshold (e.g., 50% power consumption) to a lower or zero level. The duration of the ramp down period may be determined by the IC 100 or any other suitable component of IC 100. In some examples the duration of the ramp up period or the threshold may be dependent of the potential power associated with the workload. In some examples, the CE 102 may return to a zero level indicating that no power is being utilized in IC 100 following the ramp down period. In an example, when a workload signal associated a non-qualified compute (e.g., nq compute) is received during a ramp down period, the CE 102 may immediately stop background computation before the completion of the ramp down period.

It is contemplated that the method 200 may be altered for an idle state, wherein the idle state may be the CE 102 performing background computation continuously, such that IC 100 may be at a threshold level of power consumption continuously. Although FIG. 2 shows example steps of method 200, in some implementations, method 200 may include additional steps, fewer steps, different steps, or differently arranged steps than those depicted in FIG. 2. Additionally, or alternatively, two or more of the steps of method 200 may be performed in parallel. It is contemplated that the one or more steps may occur on one device or multiple devices, which may not necessarily be CE 102.

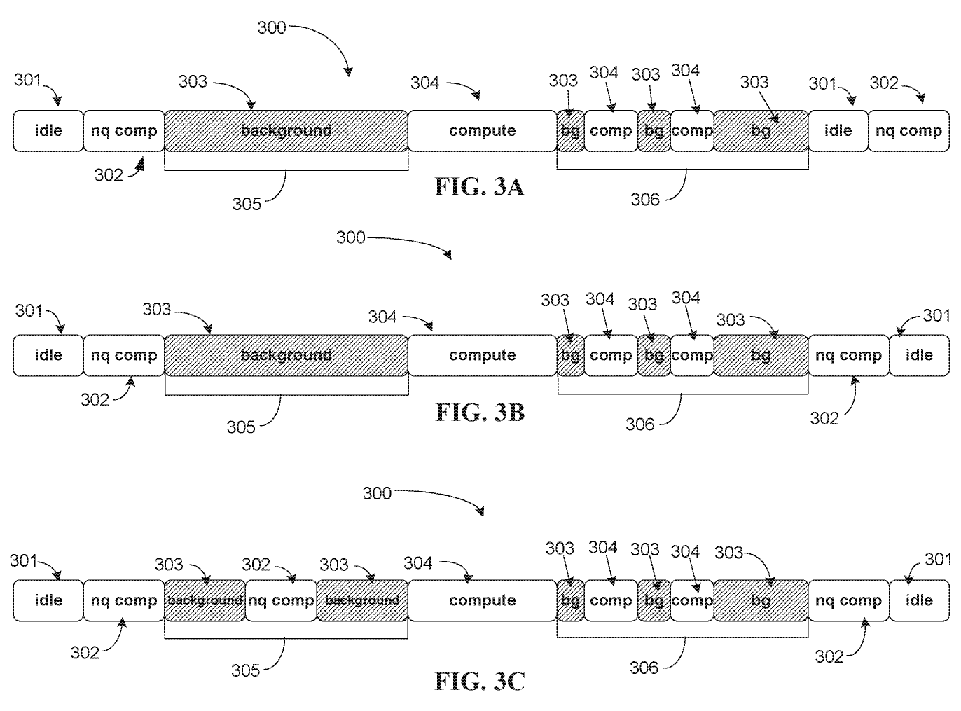

FIG. 3A, 3B, and 3C may illustrate an example process 300. Each of the FIG. 3A, 3B, and 3C may show different iterations or examples of the processes 300 based on one or more different workload signals received. Referring to FIG. 3A, the process 300 may start with an idle 301. Idle 301 may be defined as a power consumption equal to zero associated with IC 100. One or more workload signals may be received at a compute engine (e.g., CE 102). One of the one or more workload signals may be above or below the workload threshold. In response to receiving a workload signal below a workload threshold the CE 102 may compute a non-qualifying compute 302 (e.g., nq compute 302). In response to receiving a workload signal above the workload threshold the CE 102 may receive a first signal associated with a background compute 303 in a ramp up period 305 (as discussed in step 204). Following the ramp up period 305, the CE 102 may initiate a compute 304 associated with the workload signal above the workload threshold. Following the compute 304 the processor 101 may send a second signal to be sent to the CE 102 to initiate background computation within a ramp down period 306. In the event that one or more workload signals are received above the workload threshold, the CE 102 may compute the workload (e.g., compute 304). Following compute 304, ramp down period 306 may continue to repeat until the ramp down period 306 is complete. When the ramp down period 306 is complete the CE 102 may stop computation and return to idle 301.

Referring to FIG. 3B, the process 300 may start with an idle 301. Idle 301 may be defined as a power consumption equal to zero associated with IC 100. One or more workload signals may be received at a compute engine. One of the one or more workload signals may be above or below the workload threshold. In response to receiving a workload signal below a workload threshold the compute engine may compute a non-qualifying compute 302 (e.g., nq compute 302). In response to receiving a workload signal above the workload threshold the CE 102 may receive a first signal associated with a background compute 303 in a ramp up period 305 (as discussed in step 204). Following the ramp up period 305, the CE 102 may initiate a compute 304 associated with the workload signal above the workload threshold. Following the compute 304, the processor 101 may send a second signal to the CE 102 to initiate background computation within a ramp down period 306. In the event that one or more workload signals are received above the workload threshold, the compute engine may compute the workload (e.g., 304). Following compute 304, ramp down period 306 may continue to repeat during the ramp down period 306 in response to receiving a workload signal above the workload threshold. When the compute 304 end the ramp down period 306 may begin again until the ramp down period ends. However, as illustrated, the background compute 303 may end and immediately begin non-qualifying compute 302 prior to returning to idle 301.

Referring to FIG. 3C, the process 300 may start with an idle 301. Idle 301 may be defined as a power consumption equal to zero associated with IC 100. One or more workload signals may be received at a compute engine (e.g., CE 102). One of the one or more workload signals may be above or below the workload threshold. In response to receiving a workload signal below a workload threshold the CE 102 may compute a non-qualifying compute 302 (e.g., nq compute 302). In response to receiving a workload signal above the workload threshold the CE 102 may receive a first signal associated with a background compute 303 in a ramp up period 305 (as discussed in step 204). During the ramp up period 305, one or more non-qualifying computes 302 may be computed until a workload signal above the workload threshold is received. Following the ramp up period 305, the CE 102 may initiate a compute 304 associated with the workload signal above the workload threshold. Following the compute 304 the processor 102 may send a second signal to be sent to the CE 102 to initiate background computation within a ramp down period 306. In the event that one or more workload signals are received above the workload threshold, the compute engine may compute the workload (e.g., 304). Following compute 304, ramp down period 306 may continue to repeat until the ramp down period 306 is complete. When the ramp down period 306 is complete the CE 102 may stop computation and return to idle 301. Where further computations may be received, such as non-qualifying compute 302.

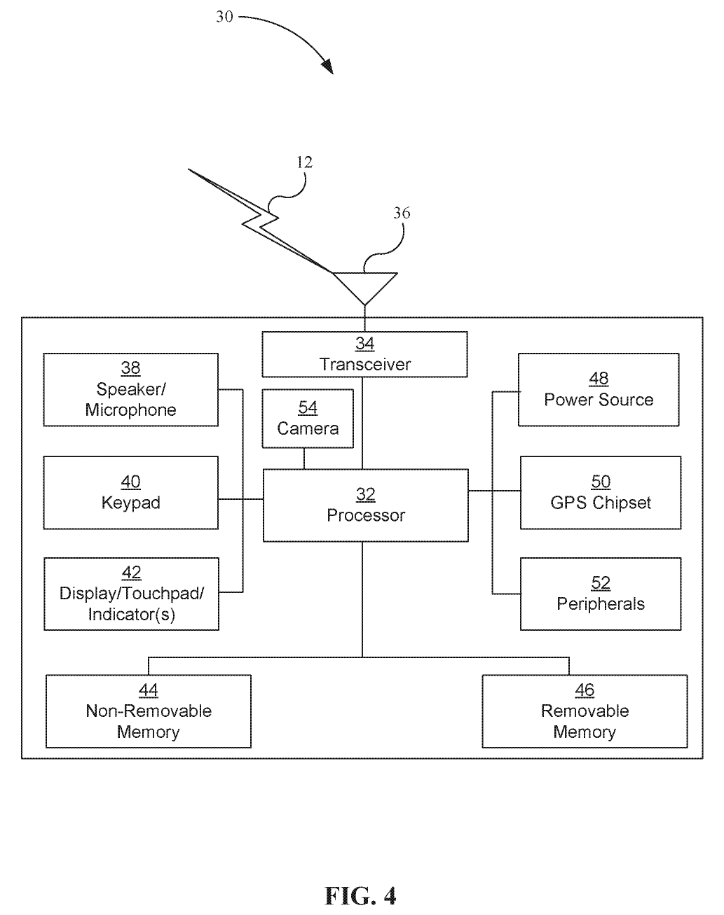

FIG. 4 illustrates a block diagram of an example hardware/software architecture of user equipment (UE) 30. As shown in FIG. 4, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

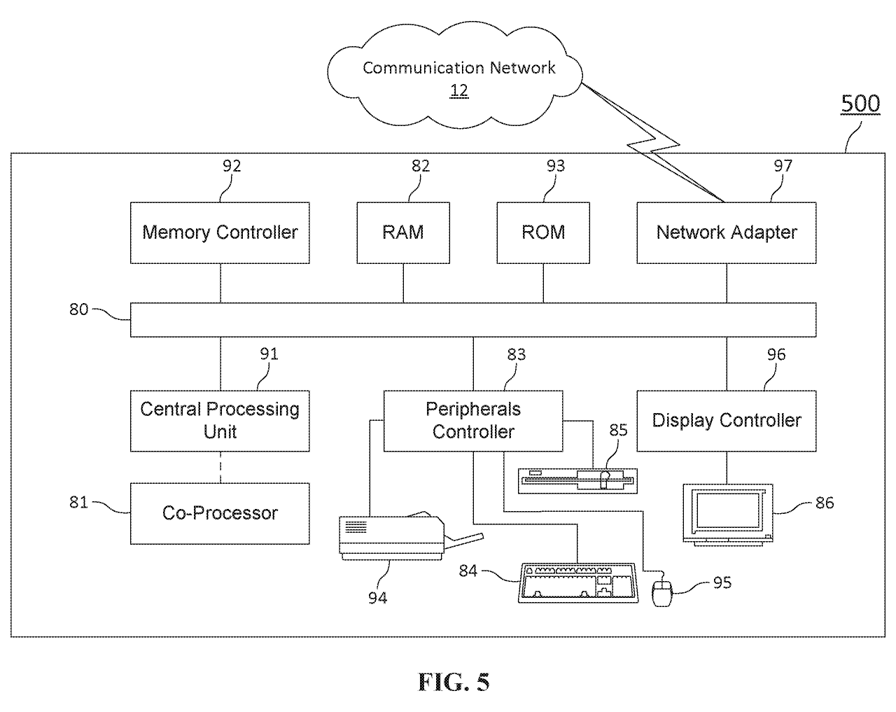

FIG. 5 is a block diagram of an exemplary computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 500 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer’s main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process’s virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 12 of FIG. 4, to enable the computing system 500 to communicate with other nodes (e.g., UE 30) of the network.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Some portions of this description describe the embodiments in terms of applications and symbolic representations of operations on information. These application descriptions and representations are commonly used by those skilled in the arts associated with integrated circuits to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

As used herein, the terms “data,” “content,” “information” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non- transitory, physical, or tangible storage medium (e.g., volatile or non-volatile memory device), may be differentiated from a “computer-readable transmission medium,” which refers to an electromagnetic signal.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving a workload signal, via a processor, wherein the workload signal is an early indicator of a workload that requires power above a workload threshold;
sending, from the first processor to a compute engine, a first signal to initiate a background computation for a ramp up period, wherein the background computation increases the power to a threshold;
performing computations, via compute engine, associated with the workload; and
sending, from the processor to the compute engine, in response to performing computations associated with the workload, a second signal, wherein the second signal initiates the background computation for a ramp down period.

2. A method comprising:
receiving a signal, wherein the signal indicates a workload that requires power above a workload threshold;
triggering, based on the signal above the workload threshold, a compute engine to initiate a background computation for a ramp up period;
performing computations associated with the signal; and
triggering, in response to the performed computations, the compute engine to initiate a background computation for a ramp down period.
